(19) United States
(12) Patent Application Publication
(10) Pub. No.: US 2010/0104267 A1
(43) Pub. Date: Apr. 29, 2010

(54) SYSTEM AND METHOD FOR PLAYING MEDIA FILE

(75) Inventors: Kim-Yeung SIP, Shenzhen City (CN); Kui-Jun WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/562,073

(22) Filed: Sep. 17, 2009

(30) Foreign Application Priority Data
Oct. 24, 2008 (CN) 200810305185.1

(51) Int. Cl. H04N 7/26

(52) U.S. Cl. 386/124; 386/E05.001

(57) ABSTRACT

A media playing system includes a media reproducing apparatus and a decoding server. The media reproducing apparatus capable of receiving a play command for reproducing a selected media file, and configured for determining whether the media reproducing apparatus can decode the selected media file, and transmitting an unsupported media format message when it is determined that the media reproducing apparatus cannot decode the selected media file. The decoding server communicatively coupled to the media reproducing apparatus, the decoding server capable of receiving the unsupported media format message from the media reproducing apparatus, and configured for invoking a decoding program according to the unsupported media format message to decode the selected media file to generate media data that can be reproduced by the media reproducing apparatus, and transmitting the generated media data to the media reproducing apparatus for reproducing by the media reproducing apparatus.

### BACKGROUND

1. Technical Field

The present disclosure generally relates to information processing technology and, particularly, to systems and methods for playing media files.

2. Description of Related Art

Nowadays more and more electronic devices, such as mobile phones and personal digital assistants (PDAs), provide media reproducing features. Electronic devices not originally designed for playing media files may have limited capability of reproducing or processing media files. In the following description, unless the context indicates otherwise, “reproducing” includes either or both of translating a sound recording into sound, and translating a video recording into images.

For a mobile phone originally designed for playing video files in Moving Picture Experts Group-4 (MPEG-4) Part 14 (i.e., MP4) format only, when a video file in a RealMedia Variable Bitrate (RMVB) format is provided, the mobile phone cannot play this video file. Users may need to utilize some conversion tools to convert the format of the video file to the MP4 format first. In practice, computers are often used to perform format-converting operations due to their powerful information processing ability. In one example, a format-converting operation is performed by a user uploading the video file in the RMVB format to a computer; actuating a format-converting program; converting the RMVB format to the MP4 format using the format-converting program; and downloading the video file in the MP4 format from the computer to the mobile phone. However, this is an inconvenient and time-consuming procedure.

Therefore, new and improved information processing systems and methods for playing media files are desired to overcome the above-described shortcomings.

### BRIEF DESCRIPTION OF THE DRAWINGS

FIG. 1 is a flowchart illustrating a method for playing a media file in accordance with an exemplary embodiment.

FIG. 2 is a block diagram showing a system for playing a media file in accordance with an exemplary embodiment, the system including a media reproducing apparatus and a decoding server.

### DETAILED DESCRIPTION

In an exemplary embodiment, a system and a method are provided for automatically decoding an encoded (compressed) media file and reproducing the decoded media file. The encoded media file may be a video file or an audio file. The system mainly includes a media reproducing apparatus, and a decoding server such as a computer. The decoding server is communicatively coupled to the media reproducing apparatus.

During a media reproducing operation, the media reproducing apparatus may receive a play command for reproducing an encoded media file stored in the media reproducing apparatus. The media reproducing apparatus may not support the media format of the encoded media file. For example, the media reproducing apparatus may only support, and able to decode, video files in MP4 format. The media reproducing apparatus transmits an unsupported media format message and, if necessary, the media file to the decoding server, for requiring the decoding server to decode the media file or an equivalent media file already stored in the decoding server. The media reproducing apparatus subsequently receives the decoded media file and reproduces the decoded media file.

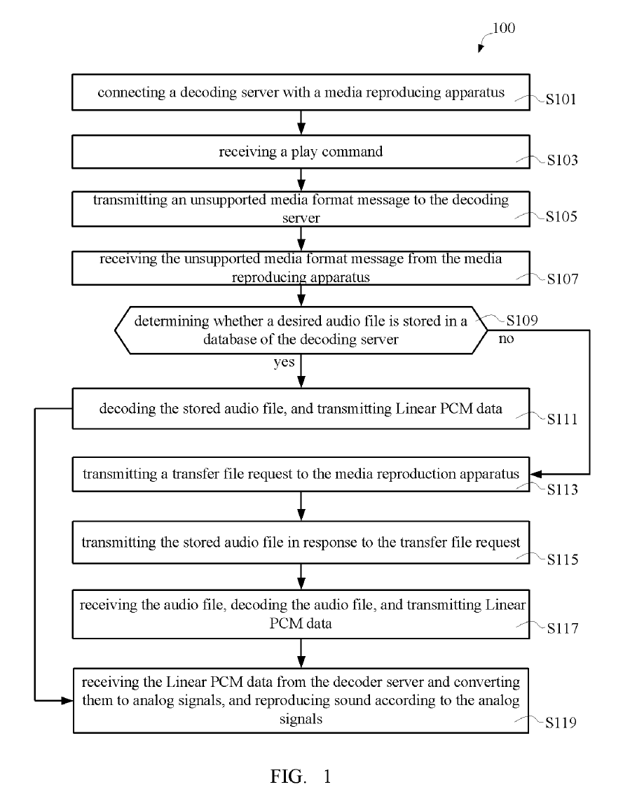

Referring to FIG. 1, a method 100 of playing a media file in accordance with an exemplary embodiment is illustrated, wherein the above mentioned playing operation is accomplished. The method 100 may be implemented by the system including the decoding server and the media reproducing apparatus. The various steps taken in performing the method 100 may be performed in the following presented order. Furthermore, in some embodiments, some steps listed in FIG. 1 may be omitted from the method 100. The method 100 includes the following steps:

Beginning in step S101, the decoding server and the media reproducing apparatus communicate with each other via a wired connection and/or a wireless connection. The decoding server and the media reproducing apparatus are also connectable to the Internet.

In step S103, the media reproducing apparatus receives a play command for reproducing a selected media file stored in the media reproducing apparatus. In this description, unless the context indicates otherwise, it will be assumed that the selected media file is an audio file.

In step S105, the media reproducing apparatus transmits an unsupported media format message to the decoding server, if the media reproducing apparatus does not support the media format of the selected audio file. The decoding server and the media reproducing apparatus may communicate with each other wirelessly using the Wireless Fidelity (Wi-Fi) standard. In one embodiment, the unsupported media format message is represented in a binary data stream. A first part of the binary data stream contains metadata of the selected audio file stored in the media reproducing apparatus, and a second part of the binary data stream indicates a decode request. The metadata of the audio file may be the name, the size, and the format of the audio file.

In step S107, the decoding server receives the unsupported media format message from the media reproducing apparatus.

In step S109, when the decoding server reads the unsupported media format message, the decoding server searches a database for a stored audio file having metadata that match the selected audio file.

In step S111, when the decoding server finds a stored audio file having matching metadata from the database, the decoding server invokes a decoding program to decode the stored audio file to Linear pulse-code-modulation (PCM) data, and transmits the Linear PCM data to the media reproducing apparatus. The Linear PCM data are obtained by sampling analog audio data at constant intervals, quantizing the sampled analog audio data, and converting the quantized analog audio data to binary data. The binary data are equivalent to digital audio data obtained by applying analog-to-digital (A/D conversion) to the analog audio data. The quality of reproduced sound depends on the sampling frequency and the number of quantization bits. From this step, the procedure goes directly to step S119 described below.

In step S113, when the decoding server cannot find a stored audio file with matching metadata, the decoding server transmits a transfer file request to the media reproducing apparatus.

In step S115, the media reproducing apparatus uploads the selected audio file to the decoding server in response to the transfer file request.

In step S117, the decoding server receives the audio file transmitted from the media reproducing apparatus, invokes the decoding program to decode the received audio file to linear PCM data, and transmits the Linear PCM data to the media reproducing apparatus. From this step, the procedure goes directly to step S119 described below.

In step S119, the media reproducing apparatus receives the linear PCM data obtained by decoding from the decoding server, converts the linear PCM data to analog signals, and reproduces sound according to the analog signals.

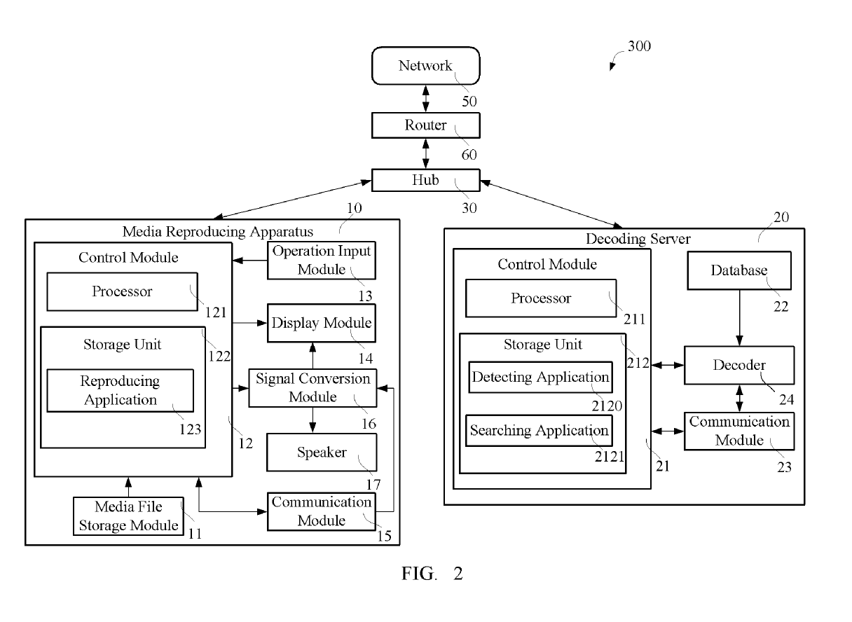

Referring to FIG. 2, this shows a media playing system 300 in accordance with an exemplary embodiment. The media playing system 300 is provided for automatically decoding an encoded media file and reproducing a decoded media file. The encoded media file may be a video file or an audio file. In the following description, unless the context indicates otherwise, a reference to a “video file” includes a reference to a file that contains both video data and audio data. The system 300 mainly includes a media reproducing apparatus 10 and a decoding server 20. The media reproducing apparatus 10 and the decoding server 20 are connected to a network 50 through a hub 30. The media reproducing apparatus 10 and the decoding server 20 may be hardwire connected or wirelessly connected to the hub 30. The hub 30 is connected to the network 50, such as the Internet, through a router 60.

The media reproducing apparatus 10 may include a media file storage module 11, a control module 12, an operation input module 13, a display module 14, a communication module 15, a signal conversion module 16, and a speaker 17.

The media file storage module 11 may be a recording medium, such as a hard disk or a flash memory. The media file storage module 11 is used for storing encoded media files recorded by a camera or downloaded from a network. The media files may be audio files in a predetermined format, such as Moving Picture Experts Group Audio Layer III (MP3) format, or Windows Media Audio (WMA) format. The media files also may be video files in a predetermined format, such MP4 or RMVB.

The control module 12 includes a processor 121 and a storage unit 122. The processor 121 is configured to execute or run various software components stored in the storage unit 122 to perform various functions for the media reproducing apparatus 10, and to control the operations of the media reproducing apparatus 10. The storage unit 122 includes one or more types of memory, such as read only memory (ROM) and random access memory (RAM). The storage unit 122 may store a reproducing application 123.

The operation input module 13 is formed, for example, of a button, a keyboard, or a touch sensitive panel. The operation input module 13 receives operation inputs of a user, and outputs corresponding instructions to the control module 12.

The display module 14 is formed, for example, of a liquid-crystal display (LCD), and displays text or images under the control of the control module 12.

The communication module 15 transmits and receives information to and from the decoding server 20 through the hub 30 under the control of the control module 12.

The signal conversion module 16 receives decoded media data from the decoding server 20 through the communication module 15, converts the received media data to analog signals, and outputs the analog signals to the speaker 17 to reproduce the corresponding sound and/or to the display module 14 to reproduce the corresponding image.

The reproducing application 123 stored in the storage unit 122 includes various software components and/or sets of instructions, which may be implemented by the processor 121. Such software components and/or sets of instructions can perform functions such as: generating a play command; generating an unsupported media format message, and transmitting the unsupported media format message to the decoding server 20 through the communication module 15; receiving information transmitted from the decoding server 20 through the communication module 15; controlling the display module 14 and/or the speaker 17 to reproduce images and/or sound according to the media data; and reading the media file from the media file storage module 11, and transmitting the media file to the decoding server 20 through the communication module 15. In practice, the unsupported media format message is represented in a binary data stream. A first part of the binary data stream contains metadata of the selected media file stored in the media file storage module, and a second part of the binary data stream indicates a decode request.

The decoding server 20 includes a control module 21, a database 22, a communication module 23, and a decoder 24.

The control module 21 includes a processor 211 and a storage unit 212. The processor 211 executes or runs various software components stored in the storage unit 212 to perform various functions for the decoding server 20, and controls the operations of the decoding server 20.

The database 22 is formed of a recording medium, such as a hard disk or a flash memory. The database 22 is used for recording encoded media files.

The communication module 23 transmits and receives information to and from the media reproducing apparatus 10 through the hub 30 under the control of the control module 21. For example, the communication module 23 receives the unsupported media format message and audio/video files from the media reproducing apparatus 10, and transmits decoded audio/video data and other information to the media reproducing apparatus 10.

The decoder 24 reads a predetermined encoded media file from the database 22 and decodes the media file to decoded media data, or receives an encoded media file through the communication module 23 and decodes the received media file to decoded media data. The media data may be audio data and/or video data.

The storage unit 212 includes one or more types of memory, such as read only memory (ROM) and random access memory (RAM). The storage unit 212 may store a detecting application 2120, and a searching application 2121.

The detecting application 2120 includes various software components and/or sets of instructions, which may be implemented by the processor 211. Such software components and/or sets of instructions can perform functions such as: detecting the unsupported media format message; and determining whether the communication module 23 receives the unsupported media format message in order to execute the searching application 2121.

The searching application 2121 includes various software components and/or sets of instructions, which may be implemented by the processor 211 for searching the database 22 for a stored media file having metadata that match the selected media file. If the processor 211 does not find a media file having matching metadata in the database 22, the processor 211 generates a transfer file request and transmits the transfer file request to the media reproducing apparatus 10 through the communication module 23. If the processor 211 finds a media file having matching metadata in the database 22, the processor 211 controls the decoder 24 to decode the found media file.

As described above, when the media reproducing apparatus 10 cannot play the media file, the media reproducing apparatus 10 transmits the media file to the decoding server 20. The decoding server 20 automatically decodes the encoded media file to decoded media data, and transmits the media data to the media reproducing apparatus 10 for reproducing into the corresponding sound and/or images.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A system for reproducing an encoded media file, the system comprising:
a media reproducing apparatus capable of receiving a play command for reproducing a selected media file, and configured for determining whether the media reproducing apparatus can decode the selected media file, and transmitting an unsupported media format message when it is determined that the media reproducing apparatus cannot decode the selected media file; and
a decoding server communicatively coupled to the media reproducing apparatus, the decoding server capable of receiving the unsupported media format message from the media reproducing apparatus, and configured for invoking a decoding program according to the unsupported media format message to decode the selected media file to generate media data that can be reproduced by the media reproducing apparatus, and transmitting the generated media data to the media reproducing apparatus for reproducing by the media reproducing apparatus.

2. The system according to claim 1, wherein the unsupported media format message transmitted from the media reproducing apparatus is represented in a binary data stream, a first part of the binary data stream contains metadata of the selected media file stored in the media reproducing apparatus, and a second part of the binary data stream indicates a decode request.

3. The system according to claim 1, wherein the decoding server is further configured for searching media files stored in the decoding server, and determining whether any of the searched media files matches the unsupported media format message, when the decoding server receives the unsupported media format message.

4. The system according to claim 3, wherein the decoding server is further configured for decoding a matching media file to generate the media data and transmitting the media data to the media reproducing apparatus, when the decoding server determines that one of the searched media files matches the unsupported media format message.

5. The system according to claim 3, wherein the decoding server is further configured for transmitting a transfer file request to the media reproducing apparatus, when the decoding server determines that no searched media file matches the unsupported media format message; and the media reproducing apparatus is further configured for transmitting the selected media file to the decoding server in response to the transfer file request.

6. The system according to claim 1, wherein the media reproducing apparatus is further capable of receiving the media data decoded by the decoding server, and is further configured for converting the media data to analog signals and generating reproducing output according to the analog signals.

7. A method for reproducing an encoded media file, the method being implemented by a system including a decoding server and a media reproducing apparatus storing an encoded media file, the method comprising:
receiving a play command requiring the media reproducing apparatus to decode an encoded media file corresponding to the play command;
determining whether the media reproducing apparatus is capable of decoding the encoded media file;
generating an unsupported media format message requiring the decoding server to execute a decoding function when it is determined that the media reproducing apparatus is not capable of decoding the encoded media file;
transmitting the unsupported media format message to the decoding server;
receiving the unsupported media format message from the media reproducing apparatus;
decoding the encoded media file to generate media data; and
transmitting the generated media data to the media reproducing apparatus for reproducing by the media reproducing apparatus.

8. The method according to claim 7, further comprising:
determining whether a media file stored in the decoding server matches the encoded media file to be decoded by the media reproducing apparatus based on information on the encoded media file contained in the unsupported media format message; and
invoking a decoding program of the decoding server to decode a matching media file when it is determined that a media file stored in the decoding server matches the encoded media file.

9. The method according to claim 8, further comprising:
transmitting a transfer file request to the media reproducing apparatus when it is determined that no media file stored in the decoding sever matches the encoded media file;
transmitting the encoded media file stored in the media reproducing apparatus to the decoding server in response to the transfer file request;
receiving the encoded media file transmitted from the media reproducing apparatus; and
invoking the decoding program to decode the encoded media file to the media data.

10. The method according to claim 7, further comprising:
converting the media data to analog signals; and
generating reproducing output according to the analog signals.

11. The method according to claim 7, wherein the unsupported media format message is represented in a binary data stream, a first part of the binary data stream contains metadata of the selected media file stored in the media reproducing apparatus, and a second part of the binary data stream indicates a decode request.

12. A medium having stored thereon one or more programs that, when executed by a media reproducing apparatus of a media playing system, cause the media reproducing apparatus to:
read an encoded media file from a media file storage module of the media reproducing apparatus;
determine whether the read media file can be decoded by the media reproducing apparatus; and
transmit an unsupported media format message to a decoding server upon a determination that the read media file cannot be decoded by the media reproducing apparatus, so as to cause the decoding server to execute a decoding operation for the media reproducing apparatus.

13. The medium according to claim 12, wherein the unsupported media format message is represented in a binary data stream, a first part of the binary data stream contains metadata of the selected media file stored in the media reproducing apparatus, and a second part of the binary data stream indicates a decode request.
